(19) United States
(12) Patent Application Publication
(10) Pub. No.: US 2006/0277156 A1
(43) Pub. Date: Dec. 7, 2006

(54) Apparatus and method for integrating enterprise market planning processes and information systems (EMP) with enterprise resource planning processes and information systems (ERP) in emerging brand companies

(76) Inventor: Yasmin Merican, Kuala Lumpur (MY)

Correspondence Address: BAKER & HOSTETLER LLP, WASHINGTON SQUARE, SUITE 1100, 1050 CONNECTICUT AVE. N.W., WASHINGTON, DC, 20036-5304, US

(21) Appl. No.: 11/235,363

(22) Filed: Sep. 27, 2005

(30) Foreign Application Priority Data
Jun. 2, 2005 (MY) PI20052524

(51) Int. Cl. G06F 17/30

(52) U.S. Cl. 707/2

(57) ABSTRACT

A method of establishing a new category in enterprise marketing planning (EMP) comprising of a self-contained, integrated, stand-alone system with three interconnecting subsidiary systems: Enterprise Market Planning (EMP) Modules, Competitor Signalling Environment (CSE) Portal and EMP Project Management (PMO) System through which integration of operational with market planning data and processes at strategic and/or corporate planning levels may provide enhanced market competitiveness to emerging brand and emerging market companies without sufficiently deep process/systems integration knowledge, experience and capabilities a business mission-critical central data integration and messaging system with built-in content, formats, rules, and processes to enable the optimisation of business strategies within existing Enterprise Resource Planning systems (ERP) through strategic intervention of the Enterprise Market Planning system (EMP), wherein the EMP System is configured to reduce the lack of convergence between operational and market planning processes for improved investment prioritisation in competitive market and brand performance an integrated, modular, and content-rich enterprise market planning system designed to accelerate organisational learning, collaboration and competencies in market and brand competitiveness processes from market and customer knowledge to communications and technology alignment, market performance measures, rules and formats via a single, unified data access and retrieval point and an integrated business information management system that may shape essential market and brand convergence behaviours enterprise-wide among assigned users within emerging brand and/or emerging market enterprises seeking to align business activities, investments, systems and competencies in the building of stronger and more globally-competitive corporate, product and service brands.

### FIELD OF PRESENT INVENTION

The invention relates to a new category in Enterprise Market Planning (EMP) systems for companies without sufficiently deep enterprise market and brand planning knowledge and experiences. In particular, it relates to the alignment of prevailing business methods, processes and systems in enterprise market planning and/or strategic brand creation with Enterprise Resource Planning (ERP) information management systems through the strategic EMP planning “filter” or interface. Enterprise market planning and strategic brand creation is defined as a synonymous and/or parallel business process where the focus and direction of the EMP is to drive the enhancement and alignment of market competitiveness processes and systems for emerging brand companies. Such companies are those seeking to grow market and brand advantage around the world, but where gaps in competitive market knowledge and brand creation experiences prevail. (FIG. 1)

The present invention is called the market-think® EMP or Enterprise Market Planning System. The technology and process embodiments of the invention are contained in three subsidiary systems: The EMP Modules, the CSE Portal and the EMP PMO System. Each subsidiary system, which integrates within the main EMP System and may be deployed to connect to existing and future ERP systems, is designed to function individually or collectively in suites of modules where the number and combination of modules may be customised to suit particular phases of business growth and market competitiveness profiles.

### BACKGROUND

In today's competitive business environment, the long term health of any growing business continues to hinge on the ability to sustain corporate, product and/or service competitiveness through operational and market excellence. However, as the intrinsic strengths of companies around the world differ, market equalisers are becoming few and far in between. Invariably, as information and communications technologies (IT) advance and shape the way industries and companies deliver their products and services, market advantage goes to those with deeper and more extensive knowledge and experiences in efficient people, process and systems enablement.

Within the larger, more market-oriented enterprises with institutionalised skills and experiences in strategic market and brand creation, the integration of strategic data between corporate planning and subsidiary functions (at finance, human resource, manufacturing, logistics, customer service, sales and marketing) are generally operationalised through the structured deployment of evolving ERP systems. In practice, the key objective of ERP enablement is primarily to plan and manage the integration of strategic information enterprise-wide where ERP inventions not only connect data between the head office and subsidiary functions, but they also connect central ERP with subsidiary ERP systems across national and multinational enterprises.

However, while existing ERP inventions may employ best practices in business process and systems enablement in the efficient integration of major business processes within the more experienced and systems-mature companies of the world, companies at the relative early market growth phase are inherently disadvantaged in strategic process and system enablement relative to the experienced. As many of such emerging brand companies evolve from production and manufacturing mindsets to stronger market orientations in fast-globalising environments, these latter-growth enterprises do not always share the same experience base or sophistication in strategic process and systems integration competencies as their more mature counterparts.

Neither are such enterprises structured for cross-functional process alignment upon which today's best practice technologies continues to be designed and implemented. The urgent need for accelerated market knowledge and experiences for such companies therefore precedes optimised utility of present ERP inventions where enterprise systems enablement is less efficient within such environments not yet equipped with the prerequisite market alignment knowledge and competitiveness focus. In these early market growth companies, vertical structures and isolated lines of authority work against the optimisation of existing ERP inventions, which conversely, are driving the operational efficiencies and market excellence of the experienced and the market-enlightened enterprises of the world. (FIG. 1)

Where process and systems enablement knowledge is inadequate or not sufficiently mature, a common strategy is to adopt the embedded practices of “packaged” ERP solutions where globally-endorsed best practice processes are enabled through integrated systems applications. While ERP enablement undoubtedly improve operational and transactional efficiencies, the integration of organisational processes without convergence with competitive market knowledge and practices work against the strategic effectiveness of such ERP-enablement for those seeking to maximise returns on investments through such enterprise information management systems. (FIG. 2) Part of the challenge is sustaining internal and external stakeholder support of ERP enablement when learning cultures may not be nurtured to run in tandem with advances in global ERP best practices and inventions. Disruptions in strategic systems enablement surfaces when management commitment to ERPs systems stalls on perceived or real evidence of delayed returns on systems investment (ROI) and when market performance expectations are not aligned with process and systems enablement strategies.

Experience within emerging brand companies point to this common misalignment between the operational efficiency and the market effectiveness of ERP systems enablement. Despite the financial means and the management propensity to access the best of ERP, Business Intelligence (BI) and other enterprise planning and management solutions, companies without the prior market knowledge and systems integration competencies are unable to fully exploit the strategic value of present ERP systems in the delivery of competitive business strategies and brand creation responses.

Companies therefore vary in their intrinsic ability to exploit the enablement potential of today's information management systems which not only influence the way people work with one another, but in their effective deployment structures the competitive dynamics of any national, regional and/or global industry. The market-think® Enterprise Market Planning or EMP System was invented to respond to this gap in enterprise knowledge, perspectives and practices within emerging brand companies where the lack of such market knowledge and competitive experiences cause misalignments between operational efficiencies and market effective strategies, investments, practices and therefore impact. (FIG. 2)

The strategic objective of the market-think® EMP is to strengthen corporate knowledge and capabilities in managing the economic and measurable impact between historical market performance (market share) and future market potential (mind share) of a company through an integrated Enterprise Market Planning system. The EMP tracks the investment value as well as the competitiveness profile of each product and service within the business portfolio of emerging brand and/or emerging market enterprises, offering such companies enhanced market insights and therefore clarity in the prioritisation of resources (people, processes and systems) in the meeting of strategic growth objectives.

### DESCRIPTION OF THE PRIOR ART

Existing ERP inventions offer methods and systems for the seamless interface and scale-up of enterprise information management functionalities. Such systems implement key business requirements in the timely sharing of information between individual applications and users. The objective of the ERP is to offer users full access to a company's information resources, thereby maximising the strategic return on process and systems investments. In addition, existing ERP inventions offer knowledge management and collaborative functionalities to accelerate and reduce the cost of integrating predefined business processes and systems on multi-platform and heterogeneous legacy systems.

ERP systems have had a long history of accomplishments in information management and integration for more than three decades. These solutions offer comprehensive methods in the consolidation of virtually every business process within an enterprise from finance and human resource, to supply chain and customer relationship management. However, investing in such process and systems enablement is not as easy when process and systems knowledge and experiences are insufficiently deep. The disconnect and complexities between what evolving technologies can offer in business effectiveness and what processes need or should be integrated has long been well established. In the absence of a technology-receptive culture as to how, what and why strategic IT investments are being committed to, ERP deployment can often retard rather than improve the corporate performances of those companies at nascent stages of their process and systems integration path. The predicament resides not in the robustness of existing ERP inventions, but in the expectation of early returns on IT investments by such early growth companies unable to track the impact of process and systems enablement on strategic corporate performances.

This disparity in such systems enablement experiences in many parts of the world have created opportunities for new inventions in ERP technologies. Examples are tools that align IT investment with business benefits, facilitating the decision-making process in IT enablement for business professionals, chief information officers (CIOs) and line-of-business (LOB) managers. These solutions permit stakeholders to leverage collective knowledge and experiences to quickly identify and quantify the value that could be realised through the improvement of business processes in line with a company's objectives and needs. The output of the collaborative effort is a customised, high-level business case.

In the support of corporate performance life cycles, other inventions in strategic enterprise management (SEM) and business intelligence (BI) offer end-to-end management of business processes from planning and simulation to stakeholder relationship management. However, such inventions presuppose that companies at all stages of market evolution have the prerequisite knowledge and experience to operationalise best practice strategies, and that enterprise skills are in place to exploit the functionalities of these mature market inventions.

However, as collective knowledge and experiences will continue to be unequal across companies, and as the ability to leverage such knowledge and experiences differ, the effective use of such inventions may be limited or untimely for emerging brand companies—especially when such IT investments are not sustained and when learning cultures are not as predominant. As markets continue to be competitive and speed in the delivery of product and service offerings essential to all market players, the systemic market-aligned view in process/systems integration knowledge accords a disproportionate advantage to the market-experienced relative to those without the know how. It is in the absence of this systemic view (the ability to align back-office and production-driven processes with market needs and expectations) that evolving ERP inventions may not be fully optimised in the majority of emerging brand companies around the world. (FIG. 2)

As new information and communications technologies (ICT) continue to emerge, prioritisation of investments in the growing array of packaged IT solutions become increasingly difficult for those without the institutionalised knowledge on how to evaluate and effectively respond. While organisations with deeper competencies and integrated processes in enterprise market planning (FIG. 1—Phase 3 companies) are equipped through years of experimentation and accomplishments to confidently sequence their knowledge and systems investments in alignment with market competitive strategies, enterprises without the comparative market focus and orientations (FIG. 1—Phase 1 and 2 companies) are less able to do so. It is in the predefined business processes and systems where enterprises without the prior knowledge, skills and experiences in market competitiveness drivers are disadvantaged in the optimisation of existing ERP inventions.

While compliance to global best practices is desirable in the achievement of systems and process efficiencies and market competitiveness, the use of such solutions by emerging brand companies need to be evaluated not only from an organisational and operational, but from a market stage of growth perspective. Overt dependence on the performance impact of such best-practice solutions may negate the real value of ERP investments when not approached from the systemic and market competitiveness view already be institutionalised within the market-competitive companies of the world.

Nevertheless, regardless of this disparity in knowledge, experiences and depth of enablement rigour between the market effective and the market-ineffective, (FIG. 1) the selection, investment and-strategic deployment of present ERP, SEM and BI inventions is critical to the future performance of every company on the threshold of globalisation. What separates the market winners from the market losers of the future may be in the ability to commit and invest in effective differentiation strategies where competencies, product and market information, competitor knowledge, process and systems enablement are in continuous and strategic alignment. (FIG. 2)

Through effective deployment of ERP systems, businesses are transformed where enablement of newly integrated business processes and people behaviours lead to improved corporate performances for those with the knowledge, the will and the stamina. To equally optimise strategic returns on IT investments offered by existing and future ERP inventions, emerging brand companies need to accelerate their ability to optimise usage of ERP tools as such innovations evolve and engineer market growth for the high performing companies of the world.

To facilitate the rapid migration from production-efficiencies to market-effectiveness and deliver better convergence between what a company seeks in its growth strategies and what competitive markets demand, the EMP market-think® System introduces a new business-critical market information management system as an enterprise planning “filter” between the corporate vision and resource planning strategies of emerging brand companies.

### BRIEF DESCRIPTION OF THE DRAWINGS

FIG. 1 (Strategic Market and Brand Orientations of Companies) is a concept diagram demonstrating the differences in strategic market and brand orientations of companies around the world and the efficiency of systems and process consolidation strategies between the market-efficient (Phase 3 companies) and the market-inefficient (Phase 1 and 2 companies).

FIG. 2 (The EMP Pyramid) is a concept diagram of the demonstrating the parallel manifestations of the EMP domain relative to the ERP domain as they should function and converge in the delivery of strategic market competitiveness—where the limited focus on corporate intent for most emerging brand companies tend to lead to inefficiencies in process and systems investment and enablement. The EMP Domain reflects what may be the missing competencies, structures and experiences of market-ineffective companies. FIG. 2a (The market-think® Process Intervention in the Business Model) is a concept diagram depicting the intercession of integrated brand processes enabled by the market-think® EMP system in the development of brand “form, brand “character” and brand “delivery” in the planning and deployment of a company's strategic vision and objectives. FIG. 2b (The integrated market-think® EMP System Navigator and Overview) is a visual representation of the overall EMP System, Subsidiary Systems and Component Modules which functions (through the graphic and design interface) as the main navigator and menu to the overall EMP System.

FIG. 3 (The EMP System, Subsidiary Systems and Component Modules) is a flow chart demonstrating the present invention—the market-think® EMP (Enterprise market planning) System (100), its three subsidiary systems and their respective component modules: the EMP Modules (140 and 140n), the CSE (Competitor Scanning Environment) Portal and Modules (160 and 160n) and the EMP PMO (Project Management Office) System and Modules (170 and 170n).

FIG. 4 (Context of the EMP within the ERP Domain) is a block diagram demonstrating the first level relationship between the corporate strategy and/or planning function (01), the present EMP (Enterprise Market Planning) invention (100) and the prior art in ERP (Enterprise Resource Planning) systems (200).

FIG. 5 (Embodiments of the EMP System) is a block diagram of the EMP (Enterprise Market Planning) System (100) demonstrating the primary information flows between the central corporate planning and/or strategy function through the EMP System (100) interface and/or “filter”, the three EMP subsidiary systems: EMP Modules, CSE Portal and EMP PMO (140, 160 and 170) aligning processes and systems with existing or future ERP (Enterprise Resource Planning) processes and systems (200).

FIG. 6 (Phase 1a Strategic Blueprinting) is a block diagram of the integrated EMP (Enterprise Market Planning) system (100) demonstrating the information flows which trigger the deployment of integrated inputs/responses from the central Corporate Planning function (01) to the EMP Strategy Module (140) through the EMP Information Management (120) and Interface (130) Applications.

FIG. 7 (Phase 1b EMP Module Response) is a block diagram demonstrating the relationship between the EMP Strategy Module (140) and the subsidiary EMP Modules (140n) where detailed work planning at integrated module levels responds and informs the Strategy Module.

FIG. 8 (Phase 1c CSE Module Response) is a block diagram demonstrating the implementation of the internal and external scanning processes triggered by the CSE Portal (160) and its relationship with the EMP Database (150), the enterprise Communications Network (240) and the ERP Data Warehouse (250).

FIG. 9 (Phase 1d Consolidated Strategy Response) is a block diagram demonstrating data routes and approval flows between the Corporate Planning function (01) and the Strategy Module (140) through the approved EMP Draft Blueprint and Consolidated Strategy Response.

FIG. 10 (Phase 2a EMP Project Chartering) is a block diagram demonstrating the concurrent deployment of work processes from the EMP Strategy Module (140) to the EMP CSE Portal (160) and the EMP PMO (170). It also demonstrates the permanent and/or transient existence of the EMP Module System (140n) which either evolves into the EMP PMO (170n) or continues to function as a new and separate Strategic Brand Unit (140a).

FIG. 11 (Phase 2b EMP Project Deployment) is a block diagram demonstrating the project planning and control processes of the EMP PMO System (170 and 170n) and its constituent project modules at during the EMP deployment phase.

FIG. 12 (Phase 2c CSE Project Deployment) is a block diagram demonstrating the scanning processes of the CSE Portal (160 and 160n) and the sources of internal and external data from the EMP Database (150), the ERP Data Warehouse (250) and the enterprise Communications Network (240).

FIG. 13 (Phase 3 EMP Evolution and Institutionalisation) is a block diagram demonstrating the strategic relationship between the present invention (EMP System 100) and the prior art (ERP System 200) where the market-aligned corporate plan and/or strategy is deployed to the larger organisation via the EMP “filter” and information management system and where both operational and market performances are tracked, reported and accessible enterprise-wide.

### DETAILED DESCRIPTION OF PRESENT INVENTION

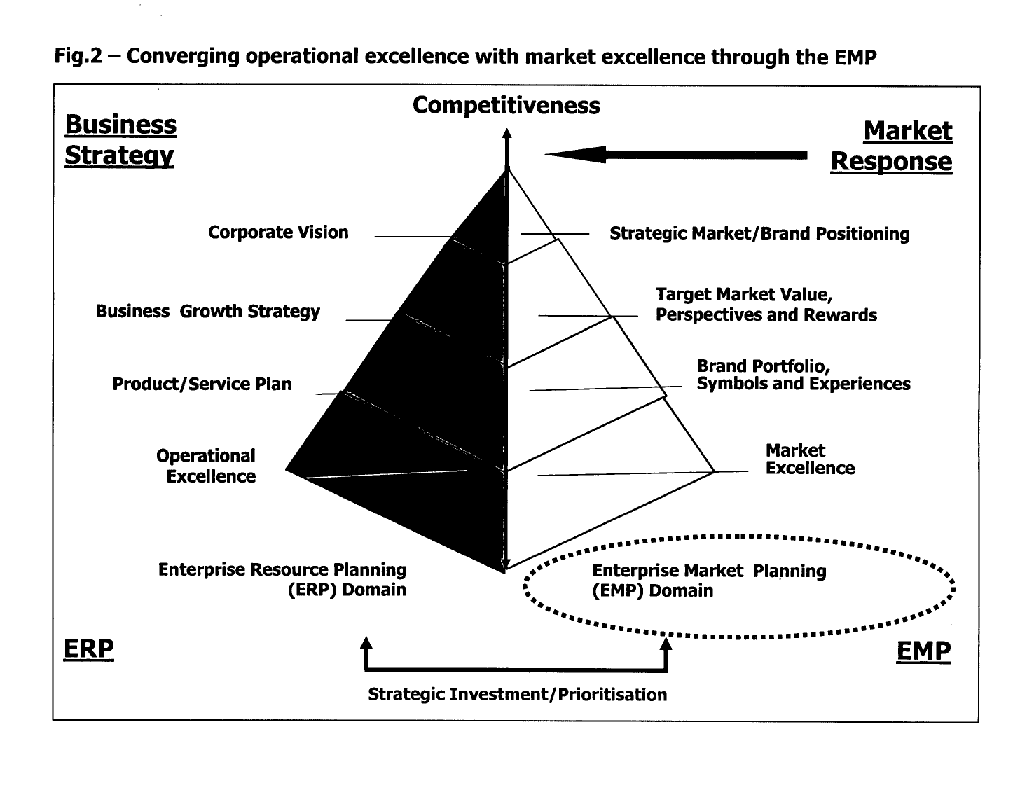

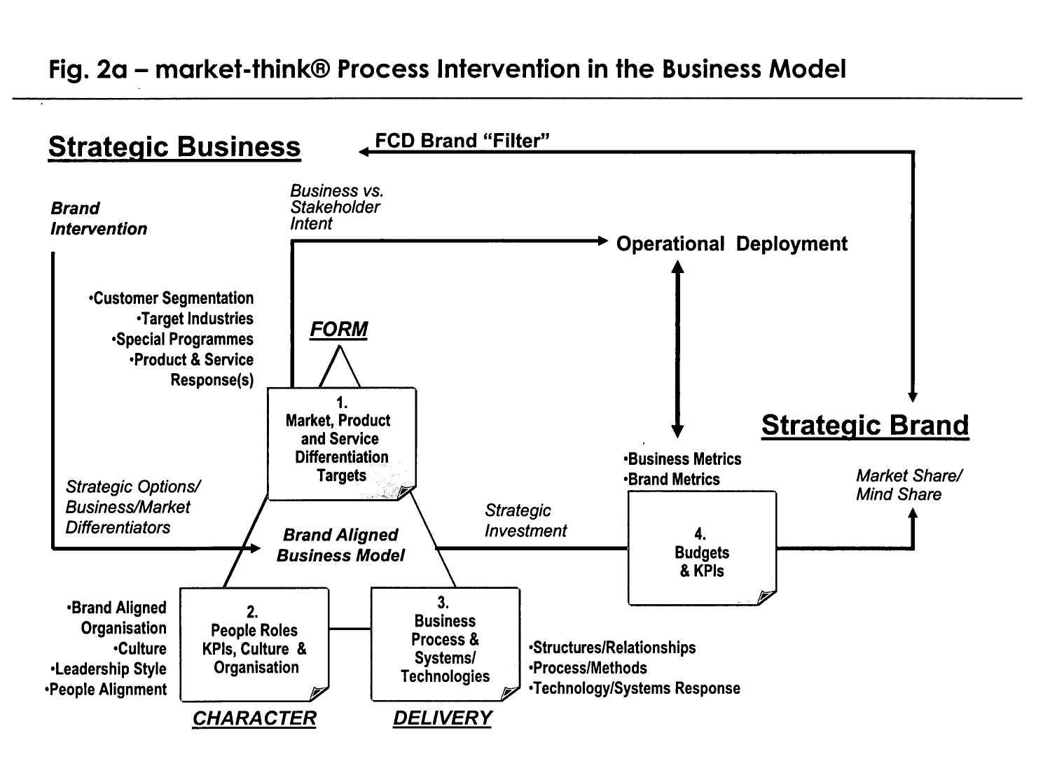

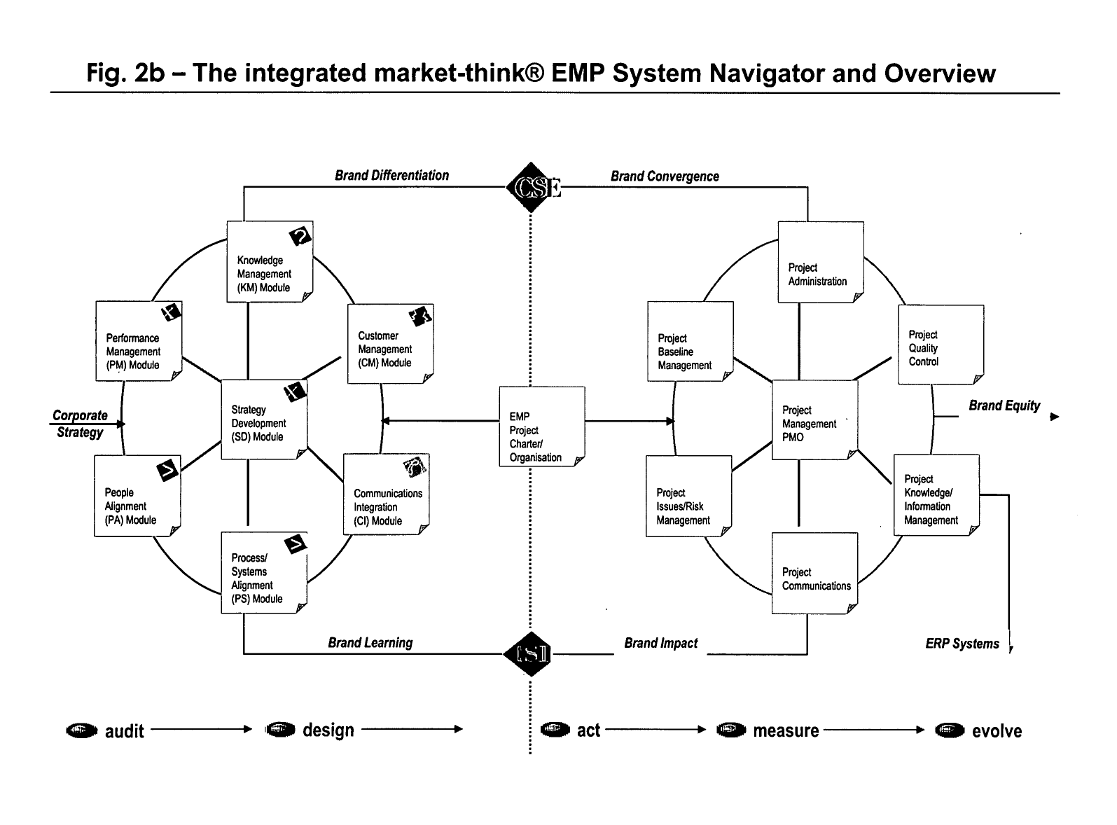

The market-think® EMP invention is as an enterprise market planning system which runs parallel to the ERP where investments in back-office processes and systems may be guided and structured by the EMP market-facing processes and systems, which competing emerging brand companies on the threshold of globalisation may need to rapidly institutionalise in the prioritisation of finite corporate resources. (FIG. 2).

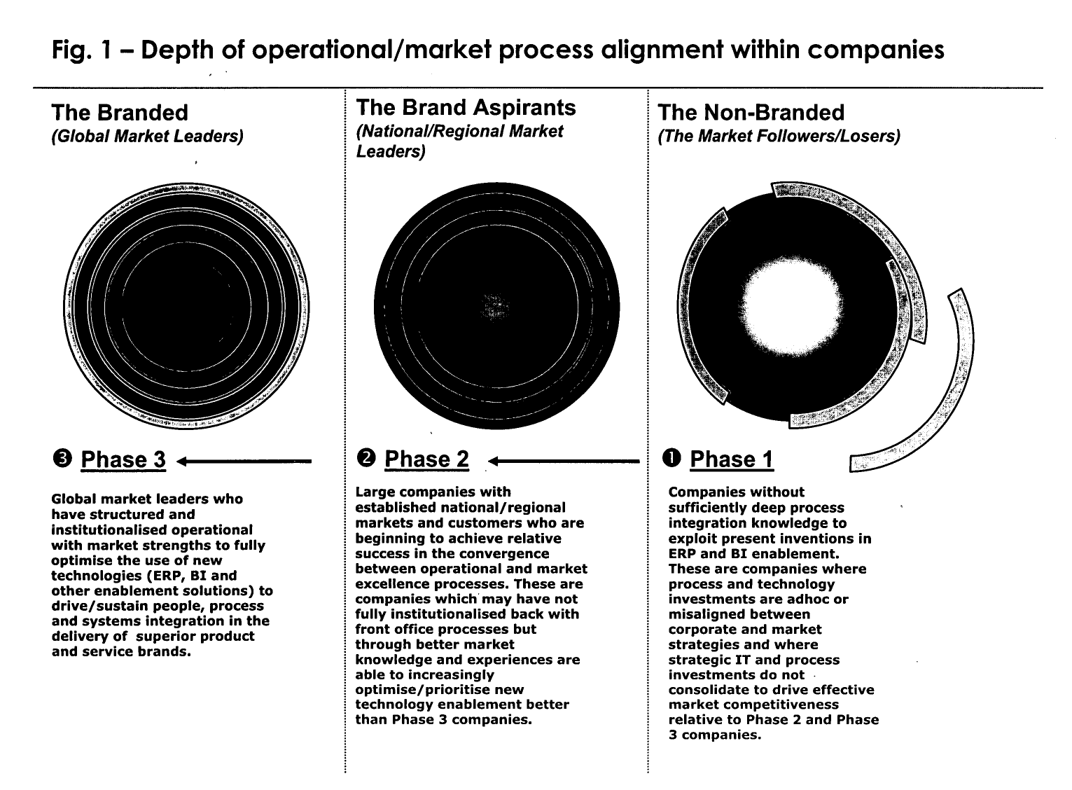

The invention functions as a strategic “filter” in the identification of critical enterprise knowledge and process gaps between operational efficiencies and market effectiveness (for. Phase 1 and 2 companies in FIG. 1), and in the definition/prioritisation of back office (operational) with front office (market) processes requiring competitive knowledge and integrated systems enablement within such enterprises. The EMP ensures that strategic investments are continually aligned to market opportunities and risks and that such investments in process, systems and competencies converge to deliver on market competitiveness and strategic brand creation objectives.

Designed to function with its own applications and database, the EMP operates first as a standalone system during the EMP Phase 1 Strategic Blueprinting Phase (140-160n) and may connect to the central data warehouse, applications and systems through integration devices once market and brand-aligned business processes, systems and competencies have simultaneously been approved for enterprise-wide deployment at the EMP Phase 2 Project Management Phase (170-170n).

Data within each of the main EMP and subsidiary systems facilitates access to market, customer and competitor information for emerging brand companies at early developmental phases of market growth where such systems and knowledge processes have yet to be institutionalised. Through the support of a project management system (EMP PMO 170) and a market and brand planning/tracking system (CSE Portal 160), critical competency gaps addressed within one or more of the EMP Modules 140n (in brand and market strategy, knowledge, customer, people/process, people, communications and performance alignment) are reduced.

By way of the parallel EMP 100 to the ERP 200 deployment, enterprise knowledge may be enhanced in the development or more market-aligned business strategies in response to globalising and competitive markets. Furthermore, automated data entries on predetermined requirements within the EMP System 100 may shape integrative people and systems behaviours at corporate or strategic levels to better converge timely and early stakeholder responses to target market objectives and brand creation opportunities.

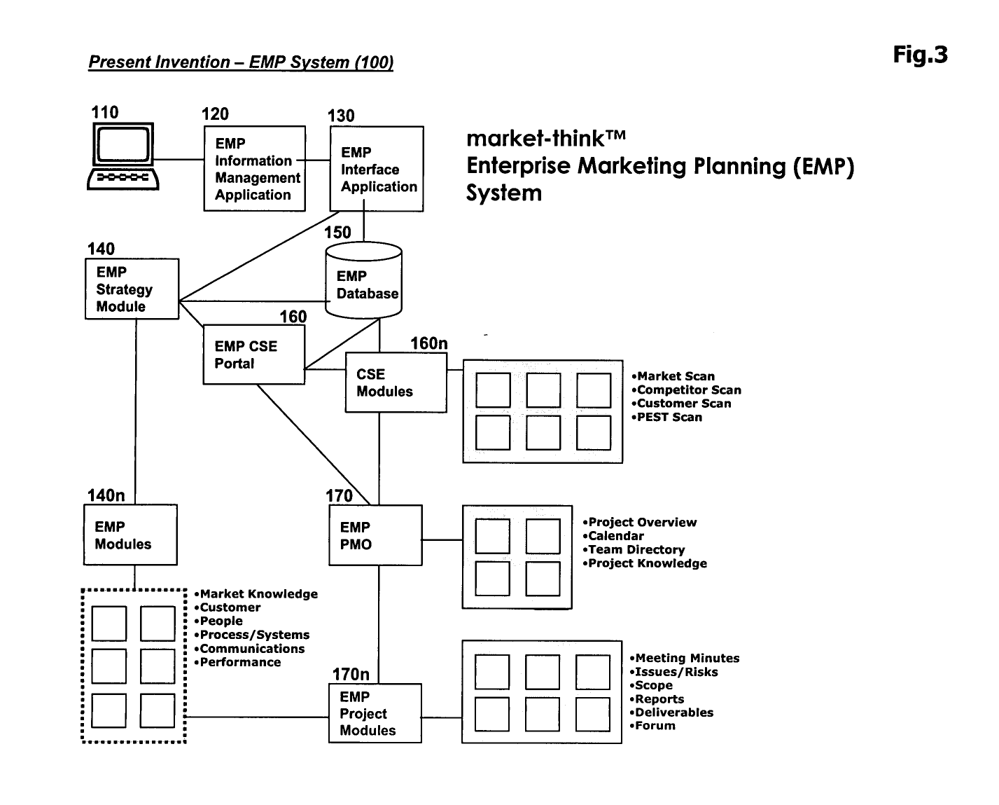

FIG. 3 is a block diagram demonstrating the high-level view of the main EMP System 100 and its subsidiary systems EMP Strategy Module 140 (and associated EMP sub-modules 140n) and CSE Portal 160 (and associated CSE modules) 160n and PMO System 170 (and associated project modules 170n).

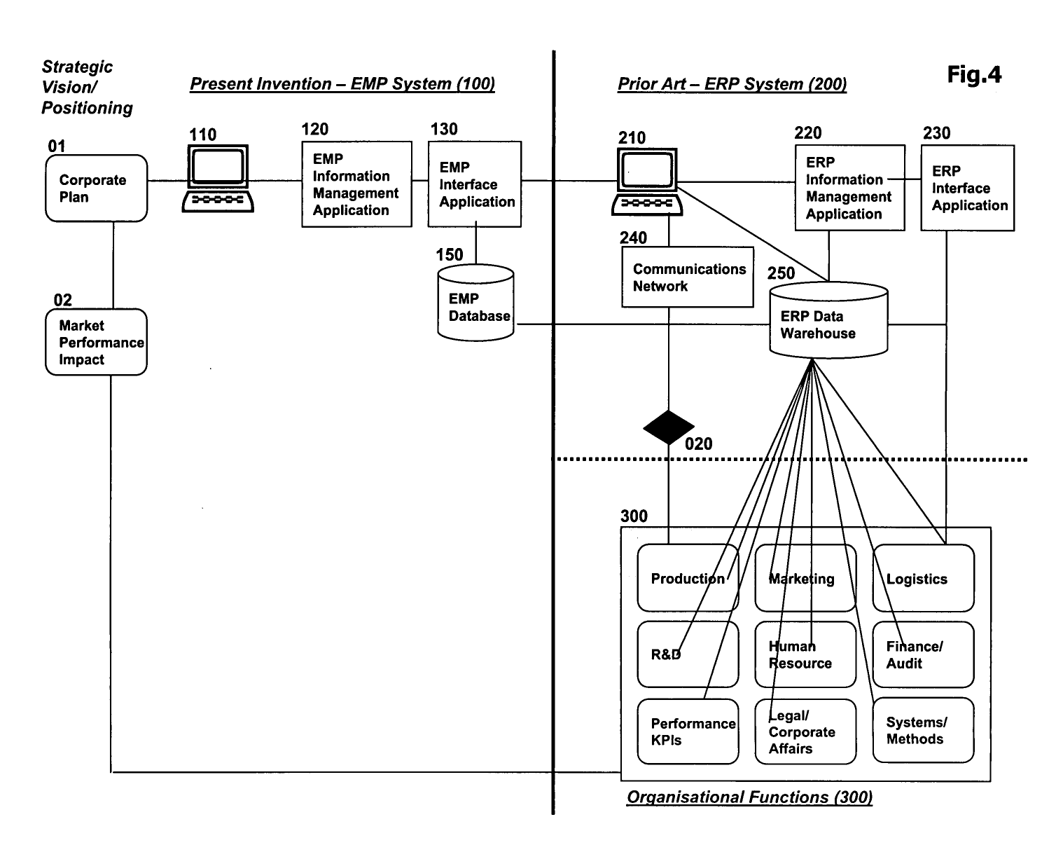

FIG. 4 is a block diagram showing the relationship between the Corporate Planning function 01 with the EMP System 100 and an example of the prior art in ERP System 200. Within the generic ERP system 200, workstation 210 for one or more users is linked to the ERP Information Management Application 220 through Interface Application 230. All EMP applications are connected to an EMP Database Application 150 which subsequently may be linked to a Data Warehouse application 250, at which consolidated enterprise data may be accessible to any one or more organisational functions/departments 300. In accordance with the present invention, user workstations 110 may run on any browser programme from major technology providers (e.g. Microsoft and/or IBM Lotus) through an Internet and/or Intranet Communications Network 240.

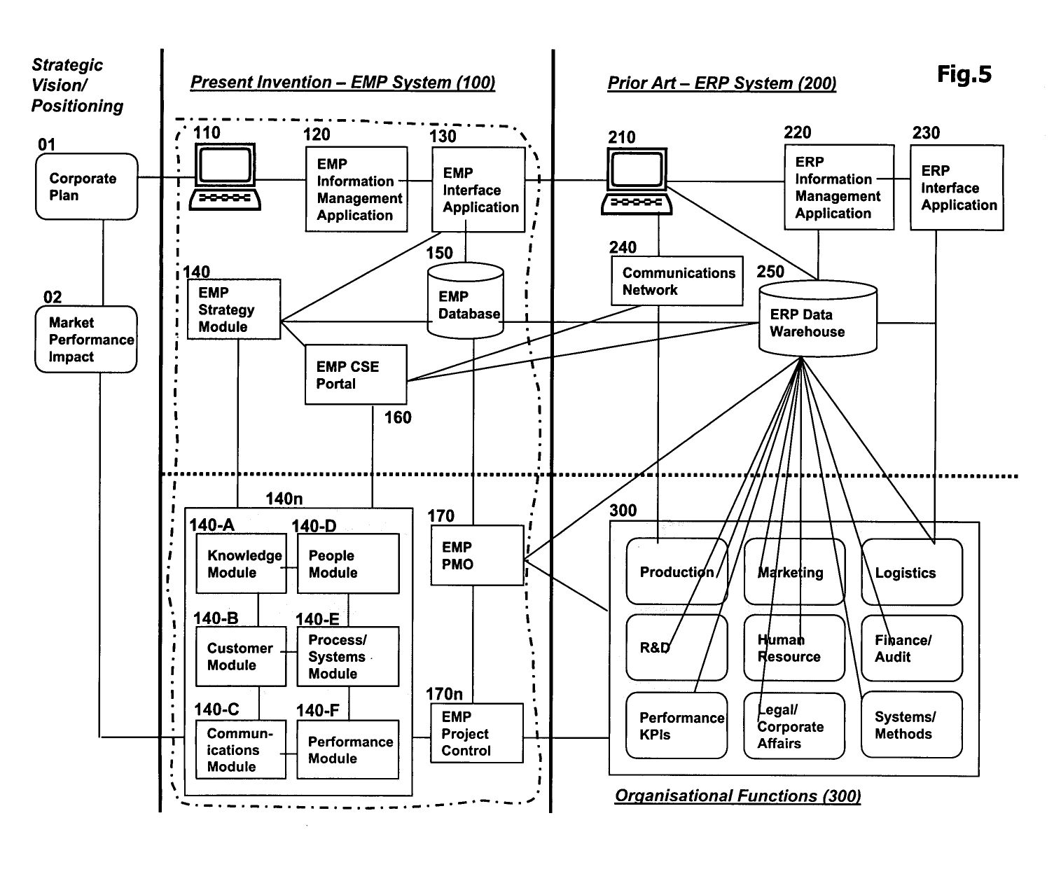

FIG. 5 is a block diagram showing the detailed embodiments of the EMP System 100 as a precedent “filter” between Corporate Plan 01 and existing or new ERP System 200. In the Phase 1 Strategic Blueprinting Phase, the deployment of the EMP System 100 precedes integration of enterprise processes with the ERP 200 System and may run on a process/systems path independent of the ERP 200 system and other existing systems enablement infrastructures.

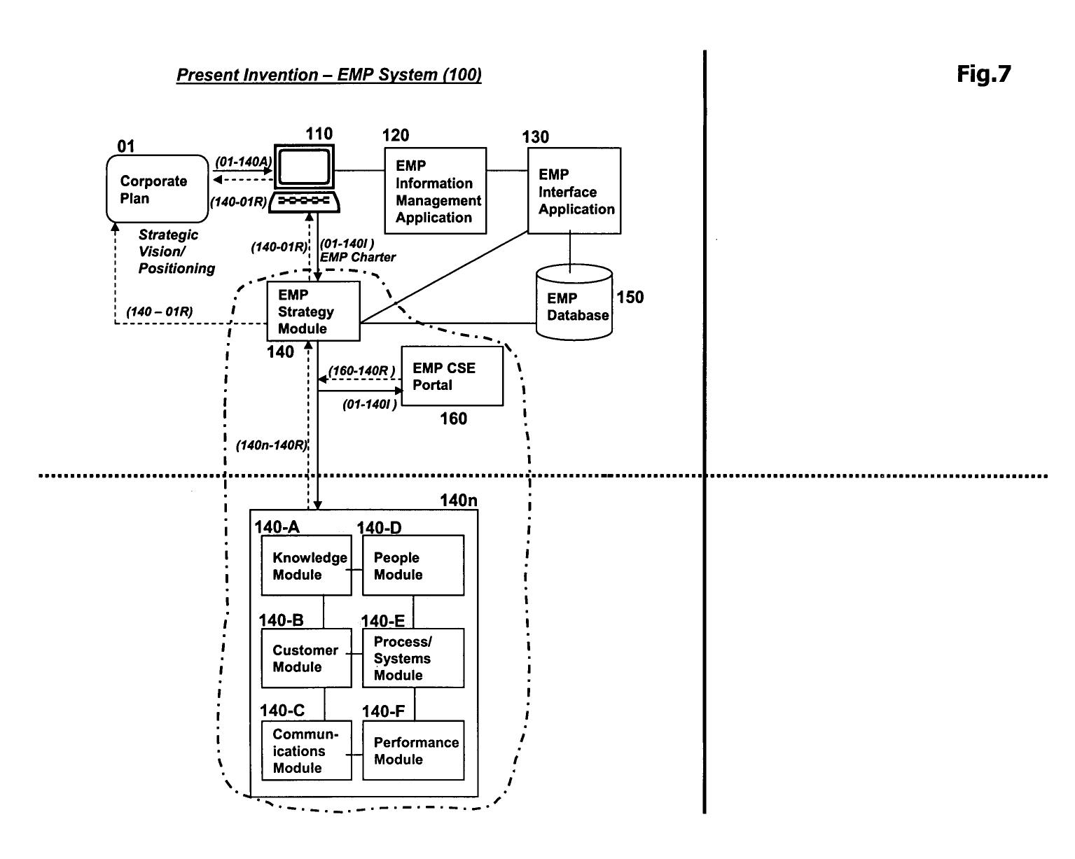

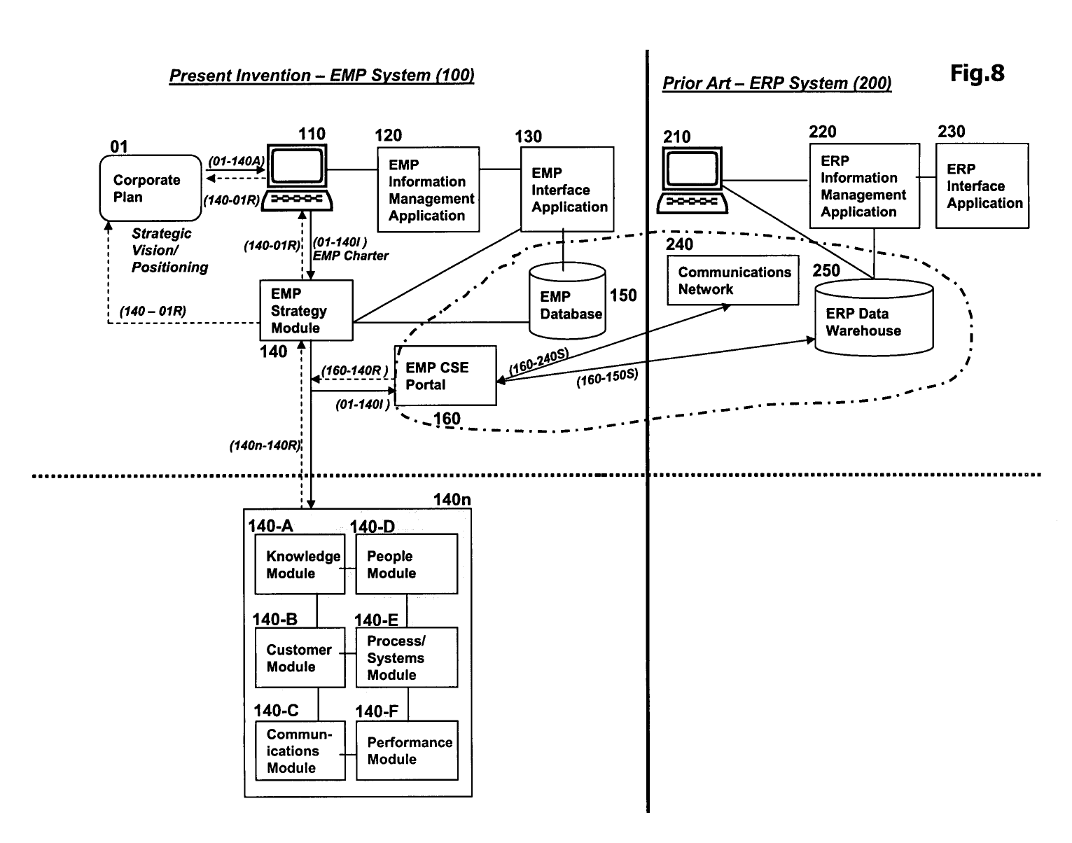

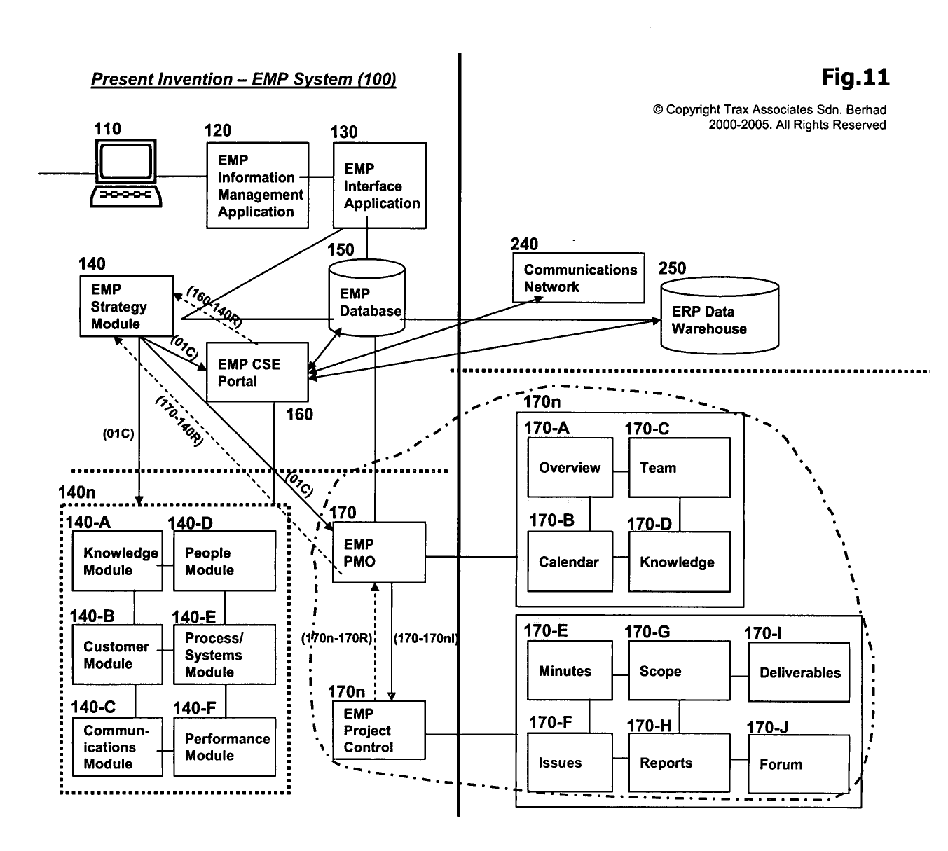

The EMP System is deployed in three (3) phases, the pace and scope of which would depend on corporate intent, size and depth of management commitment to strategic brand creation, market competitiveness and enterprise people/process/systems enablement. Phase la is the EMP Strategic Blueprinting phase (FIG. 5), Phase 1b is the EMP Module Responses phase (FIG. 7 and FIG. 8), Phase 1c the CSE Module Response, Phase Id is the EMP Consolidated Strategy Response. Phase 2a is the EMP Project Chartering Phase. (FIG. 11), Phase 2b is the EMP Project Deployment Phase and Phase 2c is the CSE Project Deployment Phase. Phase 3 is the EMP Evolution and Institutionalisation phase.

The EMP Interface Application 130 (which may run on Microsoft and/or IBM Lotus technologies) manages all information exchanges on the EMP through links with EMP Database 150 through all phases of the EMP Systems deployment. However, at the Phase 2 Project Chartering and Deployment phases, information and process flows may be integrated with ERP-enabled operations 200 through the EMP PMO System 170.

The CSE Portal 160 or the Competitor Scanning Environment connects to the enterprise Communications Network 240 (Internet and Intranet) through a universal resource locator (URL) and the ERP Data Warehouse 250 to access, store, retrieve consolidated competitor and customer information respectively throughout both the Phase 1 Strategic Blueprinting and Phase 2 Deployment Phases of the EMP System 100, where the Portal assumes the primary audit role in Phase 1 and the tracking role in Phase 2 of the EMP System. Access to various ERP 200 applications from the EMP 100 System may need to be channelled through appropriate integration devices/middleware within the overall information systems (IS) architecture.

While embodiments of the present invention: the EMP User Workstation 110, EMP Information Management Application 120, Interface Application 130, Module System 140, CSE Portal 160, PMO Project Management System 160 may be located centrally within corporate headquarters through a local area network (LAN), access to the EMP 100 System by remote subsidiaries and companies outside the central site may be made possible through a wider area network (WAN) linked to the Communications Network 240 (Internet/Intranet).

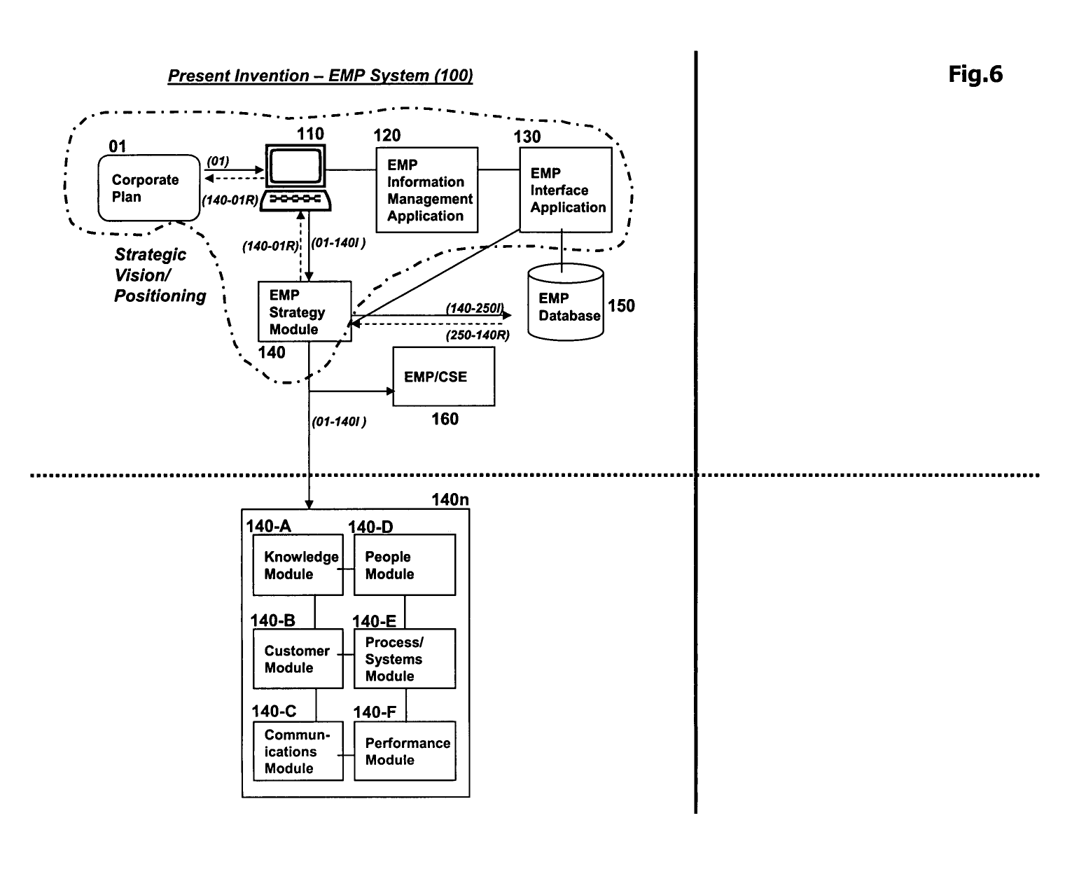

FIG. 6 is a block diagram of the EMP System 100 where user workstations 110 (which may range from one or more users within the three component systems (EMP Module 140, CSE Portal 160 and EMP PMO 160) are connected to the EMP Information Management Application 120 through Interface Application 130. The chart illustrates the information flow paths at the preliminary EMP Strategic Blueprinting Phase la where the EMP System “filter” 100 mediates between the Corporate Plan 01 and ERP System 200 through the EMP Information Management Application 120 and Interface Application 130 through the EMP Strategy Module 140. The EMP intervention ensures that critical market, customer and competitor data is factored into traditional corporate planning processes within companies without sufficiently deep market knowledge and orientations prior to strategic deployment of people, systems and processes enterprise- wide. EMP Database 150 functions independent of the Enterprise Data Warehouse 250 and may be connected to existing and/or future ERP systems 200 at a later phase.

The EMP Strategy Module 140 plays a key role in the receipt and distribution of integrated information across the EMP system. The Phase la EMP Strategic Blueprinting process begins with the Corporate Plan function 01 instructing (01-EMP) the Strategy Module 140 on the “filtering” of the company's long term strategy and budget prior to operational deployment at ERP 200 levels during the Phase 2 EMP Project Chartering and Deployment Phase.

The translation of the Corporate Plan 01 into an EMP Strategic Blueprint (01-EMP) begins at the drafting of the preliminary EMP Draft Blueprint (DB) for market and brand planning responses from EMP Modules 140n and the CSE Portal 160 to the Corporate Plan. The presentation of the Draft Blueprint (DB) with the EMP Modules 140n and the CSE Portal 160 is through a common data platform of market-aligned business strategies and processes in the EMP Information Management Application 120. The objective of the strategic EMP System 100 mediation to the ERP System 200 is to ensure the consolidation of more comprehensive and accurate responses to target market, product and service objectives from EMP Module 140n expertise and new market./competitor perspectives at the CSE Portal 160. The EMP Draft Blueprint (01-DB) once designed and approved in its final form as the EMP Strategic Blueprint (01-SB) will shape and manage enterprise responses within pre-established corporate, product and service brand portfolios and categories. The parameters set by the specific market segments, targets and activities as embodied in the EMP Strategic Blueprint (01-SB) will ensure that subsequent investments and responses in people, process, systems, and third party relationships converge within the ambit of a strategic and market-aligned corporate plan.

An example of this convergence is the identification of the specific product and service potential that should be matched and aligned with strategic investment. To create a product or service leader, enterprise stakeholders need to access knowledge on the competitive drivers of a high-performing product or service before investment can effectively be made in the support business drivers. Without access to adequate information on markets, customers and competitors, the effectiveness of strategic investments would be challenging for companies without strong market and brand orientations and capabilities. The inherent gaps in overall knowledge and competencies (as elaborated in 0032) are addressed within the EMP Information Management Application 120. Through the EMP System 100, users across the enterprise will be able to respond to the EMP Strategic Blueprint (01-SB) through a single, unified access point via the Interface Application 130 where user-friendly, built-in content, checklists and detailed “how to” cues have been programmed at the process and document level. Each corporate, product and service brand carries its own data fields, which may first be stored at EMP database 150 and later integrated into ERP Data Warehouse 250 where such data may be tracked and responded to enterprise-wide.

One such field is the charge code field for each product or service that enables future audits, valuations and assessments to capture, track and analyse the impact of strategic investments on market and product/service brand performances. Such EMP data codes and fields at the EMP System 100 level may be aligned to established ERP System 200 codes to report on the economic value being created for all market and brand investments through the consolidation of such data across product, service and brand lines. Interface Application 130 routes responses to and from target stakeholders across all EMT systems. To facilitate speed of response and accelerated learning, features on all EMP System 100 views and documents include programmed “drop down” prompts on best market and brand practices and “help” functions to support user inputs in the alignment of business intent with market growth opportunities.

FIG. 7 is a block diagram of the EMP System 100 illustrating the information flow paths between the EMP Strategy Module 140 and its subsidiary Modules 140n on the validation/modification of the EMP Draft Blueprint (01-DB) for strategic consolidation at the EMP Phase 2b Module Response phase.

The number and combination of EMP Modules 140n would hinge on the size, stage of market readiness, competencies and business scope of the company. In addition to the Strategy Module 140, in the embodiment of this invention, the Module 140n System comprises several other modules: Knowledge Module 140-A, Customer Module 140-B, Communications Module 140-C, People Module 140-D, Process/Systems Module 140-E and Performance Module 140-F. Modules may be added or hived from the EMP System 100 as and when required during the EMP Project Chartering and Deployment Phase in accordance to management preferences, where each EMP Module 140n can reside within separate databases and linked to ERP Data Warehouse 250 at a later stage.

In accordance with the present invention, the Strategy Module 140 through EMP Interface Application 130 transmits the EMP Draft Blueprint (01-DB) at the Phase 2a Module Response Phase through a consolidated view to all Modules 140n and the CSE Portal 160. One example of an EMP Module 140n interface would be the Module Response from Knowledge Module 140-A on data availability or non-availability to drive the delivery of target products and services on the EMP Draft Blueprint (DB). A second example may be the request to Customer Module 140-C to respond on the currency of customer data in response to acquisition, retention or cross-selling strategies within the EMP Draft Blueprint (01-DB). And a third example may be a request to Process/Systems Module 140-E on the efficiency of an organisation's existing and/or future systems infrastructure to drive or support the service positioning of an innovative product on the EMP Draft Blueprint (DB). This is where the market and brand “filtering” of a corporate plan or strategy occurs where through access to common data and a shared platform, an emerging brand company is able to rapidly audit and respond to market differentiation and sustenance opportunities from a competency and systems perspective. The mediation of the EMP optimises strategic investment decisions where corporate objectives are in early alignment with market opportunities and brand positionings before processes, systems and competencies are being built for the long term.

In FIG. 7, the request from EMP Strategy Module 140 is responded (01-MR) to by each of the Modules 140n for every corporate, product and service brand on the EMP Draft Blueprint (01-DB) through a Module Response document. Through messaging, calendaring, reporting and the collaborative functionalities of EMP Interface Application 130, a Consolidated Module Response (CMR) for each of the Modules 140n and CSE Portal 160 will be sent to the Strategy Module 140 for consolidation and subsequent routing through the Consolidated Strategy Response (CSR) at the Corporate Planning function 01 for management review and approval. All workstation users at Module 140n and the CSE Module 160 may view the EMP Draft Blueprint (DB) from a single data platform where convergence and of information from all participating EMP Modules is facilitated from parameters set within preestablished EMP document formats and response fields.

To ensure rapid data consolidation during Phase 1b, the information flow paths presupposes that the request and response scenarios between the Strategy Module 140 and Modules 140n and the CSE Portal 160 will occur within schedules and routings established. However, other scenarios are likely to occur where the information flows between the Strategy Module 140 and other EMP Modules 140n and the CSE Portal 160 could be more than once when or where modifications are required to Consolidated Module Responses (CMR) to accommodate strategic planning and investment decisions. The information flows are managed through approval protocols and visual messaging indicators at EMP Interface Application 130 to ensure that data routings as required by the EMP Draft Blueprint (01-DB) are structured and organised within predetermined timeframes and formats.

During the EMP Phase 1b Module Response Phase as demonstrated in FIG. 7, Modules 140n operate independent of ERP 200 systems. Data on each corporate, product and/or service brand is responded to at the individual module 140n level and merged into a Consolidated Module Response that is routed back within set timelines to the Strategy Module 140 via EMP Interface Application 130 for approval and/or review.

FIG. 8 is a block diagram showing the relationship between the CSE Portal 160 and the data flows between the Portal and the EMP Database 150, ERP Database 250 and the company's internal and external Communications Networks 240. The CSE is the only module within the EMP System 100, which may benefit from early integration with ERP 200 systems and communications networks 240 at during the Phase 1 strategic blueprinting phase. While the EMP Modules 140n establish the company's internal stage of readiness from in its consolidated responses to the EMP Draft Blueprint (01-DB), the CSE Portal 160 offers the critical data scans to external market, customer and competitor activity to surface and explore market differentiation and sustenance opportunities. In as much as the connection with the ERP 200 systems is optional at the Phase 1b Module Response Phase for all EMP Modules 140n, the CSE Portal may be connected (01-CMR) to a Communications Network 240 (an Intranet and/or Internet) via a universal resource locator (URL) to access early information on market and competitor activity in the external environment. If practicable at Phase 1c, the CSE Portal 160 may be linked to the ERP Data Warehouse 250 to enable early access to customer and other market information already captured and stored within the enterprise. (01-CMR).

Through the CSE Portal 160, users will be able to view updated information and analyses on competitor, market and customer activity. The CSE Portal 160 is a key application on the EMP information management system 100 as the consolidated market and customer data drives strategic design in Phase 1c, as well as tracks the impact of EMP processes on competitor response action, customer and market behaviours in Phase 2c at the EMP project deployment phase. The value of the CSE functionality is that in the absence of effective competitor and market knowledge, EMP stakeholders will have access to market data which is tracked on a continuous or phased basis to which continual audits and responses can progressively be captured, stored and shared across the EMP 100 and ERP 200 systems.

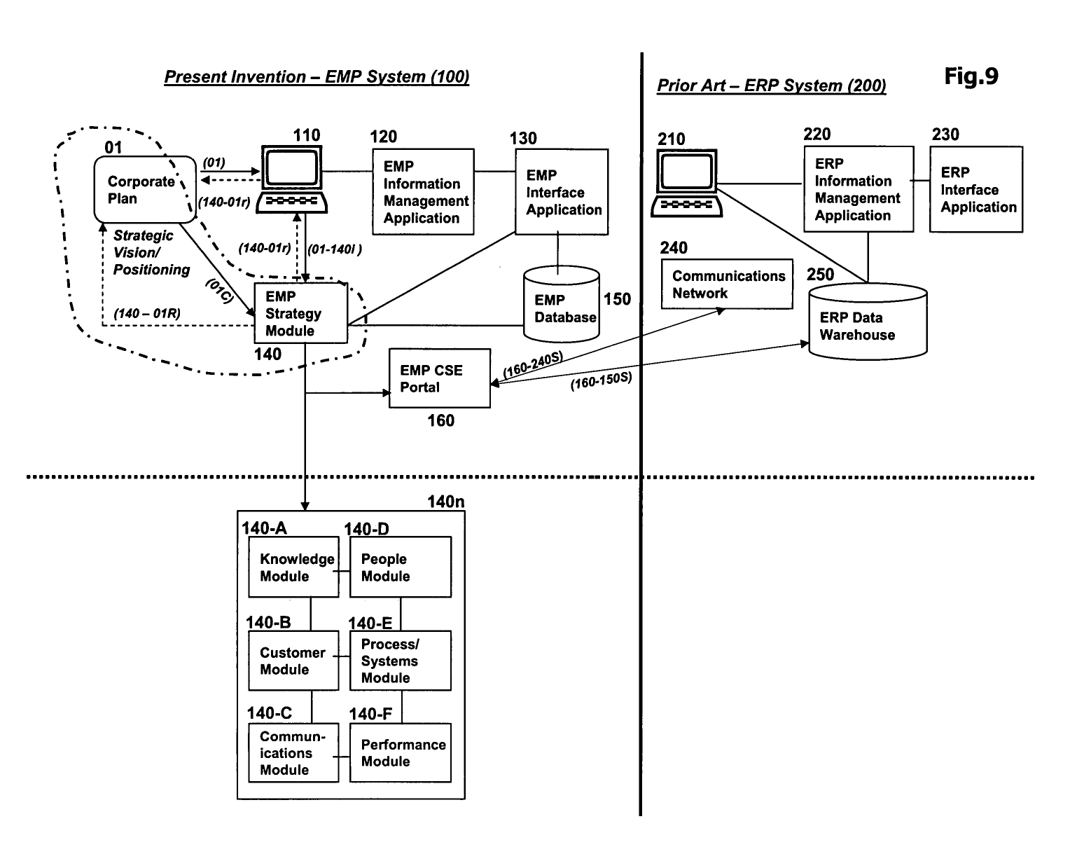

FIG. 9 is a block diagram of the EMP System 100 showing the information flow paths from Strategy Module 140 to the Corporate Planning 01 function via the Consolidated Strategy Response (CSR) for final management approval of the EMP Strategic Blueprint (SB) which subsequently drives the institutionalisation of market and brand-aligned strategies across the enterprise. At this Phase 1d, original corporate planning budgets, timelines and responsibilities may be adjusted to accommodate EMP recommendations and alignment plans before final budgets are recommended for management review and ratification. Again, the approval routing process via EMP Interface Application 130 may necessitate more than one process loop before the final EMP Strategic Blueprint (SB) is transmitted via the Strategy Module 140 for enterprise deployment in Phase 2.

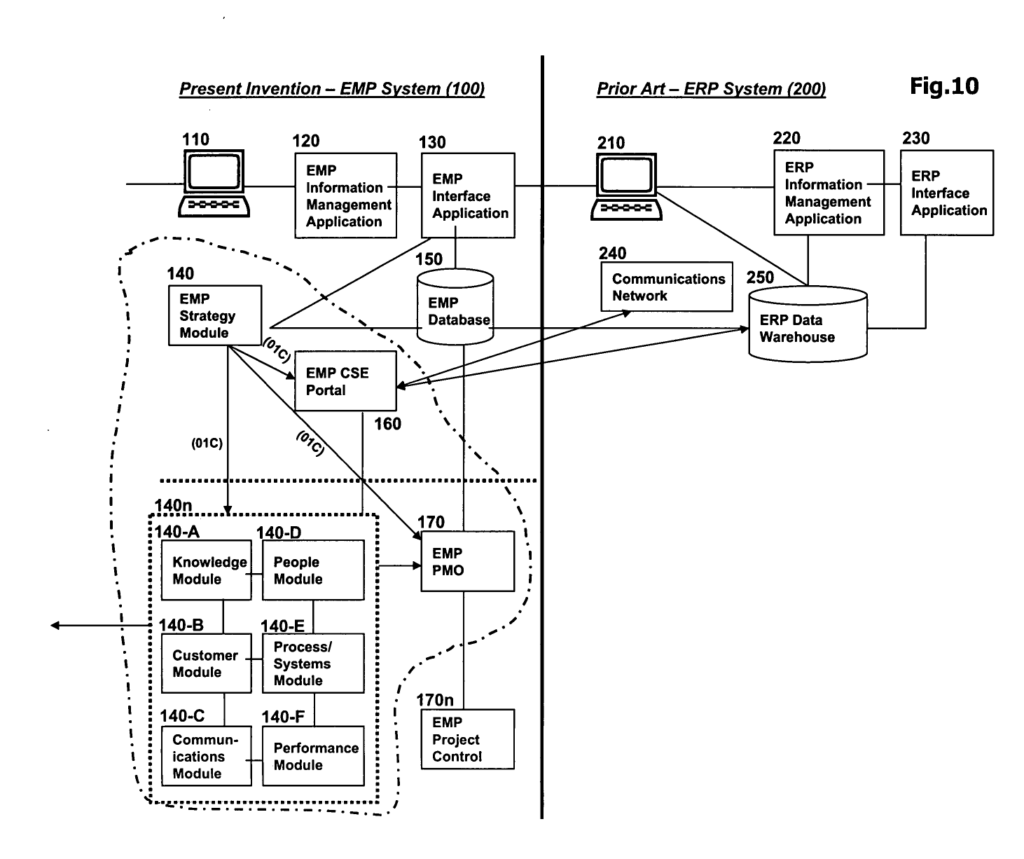

FIG. 10 is a block diagram detailing the concurrent flow paths triggered by the approved EMP Strategic Blueprint (O1-SB) from the Strategy Module 140 to subsidiary Modules 140n, PMO Module 170 and CSE Portal 160 for the Phase 2 Project Chartering and Deployment phase. The primary role of scoping and operationalising the EMP Strategic Blueprint (01-SB) resides with the PMO Module 170 and its subsidiary project planning modules 170n where the chartering of a structured programme (and integrated projects) for enterprise-wide deployment begins. The EMP Blueprint (01-SB) is also simultaneously routed to the CSE Portal 160 for market, customer and environmental tracking action where CSE Modules 160n will assume its strategic market intelligence role to support the delivery of integrated market and brand strategies within the approved EMP Blueprint (01-SB).

The strategic and permanent role of the Modules 140n will be determined at this phase where depending on the objectives and organisational preferences of the enterprise, EMP Modules 140n can migrate to function in any one of the following forms or be disbanded and absorbed into the EMP PMO function 170n during the Phase 2 Project Deployment Phase. Under the leadership of the Strategy Module 140, Module 140n may either evolve into a new Strategic Brand Unit within the corporate planning function 01 if appropriate skills and competencies are accessible; as a new Strategic Business Unit within the CEO's office to effectively drive operational with market/brand alignment during the early brand creation phase; or be absorbed as domain experts or project managers into the EMP PMO System 170n. Alternatively, Modules 140n may also be dispersed into existing organisational functions 300 where domain experts from each Module 140n may continue to work as project planners and build new competencies at functional levels through common access to Information Management Application 120.

For example, should the preferred scenario be the dispersal of the Modules 140n into organisation 300 at the EMP Phase 2 Project Deployment Phase, the People Module Leader at Module 140-D may be assigned as the Human Resource (HR) Planner within the company's HR department where integrated EMP System 100 responses may continually be aligned within ERP System 200 from the people and competency planning and building perspective. A second scenario is when the Module system 140n is absorbed into the Corporate Planning function 01 from where strategic business and market direction may emanate in parallel instead of sequentially. Should the enterprise choose not to create a new independent EMP unit due to cultural or work process issues, competencies already built within Modules 140n may be deployed to respective departments within organisation 300 who already have established information and process relationships with the Corporate Planning function 01. This may avoid process duplications in the resource planning processes of an organisation. Regardless of where each or any combination of modules finally reside, the continuity and evolution of the Modules 140n is critical in the sustenance of market and brand knowledge for enterprises without adequate skills in strategic market and brand planning. The larger and more complex the business, the more important the strategic role of the Module 140n functions in ensuring the ongoing compliance of operational with market efficiencies.

The continuation of the EMP Modules 140n either at the strategic or functional level at the EMP Phase 2 Project Deployment stage may illuminate investment priorities and/or continuation of process, people and systems enablement in any one or all of the Module areas from stronger knowledge management through to customer process, systems and communications integration. The EMP focus and the ability to share individual or team perspectives on a company's market strengths and weaknesses through a single data platform from around the organisation may create new skills for enterprises where such capabilities have yet to be created and/or institutionalised. Each of the EMP Modules 140n including the CSE Modules 160n can individually or collectively be housed in separate databases to be integrated in the future into existing and/or future ERP Data Warehouse 250.

FIG. 11 is a detailed block diagram showing the data flows between the EMP PMO 170 and its respective project modules 170n. As effective enterprise systems and process implementation is rarely achievable without strong and effective project management skills, tools and resources, the functions of the subsidiary project modules 170n range from team directory, calendaring, knowledge, minutes/reports/deliverables, issue and risk, and team forum management. The PMO 170 system supports the achievement of project protocols through an application-enabled process where the EMP PMO System 170 and subsidiary project modules 170n offer instructions in the planning, management and control of all EMP projects as they integrate with other enterprise operations. Again, just as in the Module 140n scenario in FIG. 10, the number of project modules 170n would depend on the size, scope of the EMP Strategic Blueprint (01-SB). Strategies and investment prioritisations to be deployed is driven through the resultant EMP Project Charter (01-PC) and managed principally through the PMO module 170 on Interface Application 130 and EMP Database 150. Request and approval processes for project management users travels through similar information flow paths between the EMP Project Management Office (PMO) 170 and its subsidiary projects 170n as the Module system 140n with principal Strategy Module 140.

As the information exchange throughout the EMP System 100 has to be structured and contained within predetermined business goals and expectations, timely responses by stakeholders is a critical success factor that needs to be managed through schedules, e-mail prompts and automated notifications to respective users. On the PMO 170 structure, project documentation may remain in the EMP Database 150 unless early links with ERP Data Warehouse 250 is deemed necessary to connect to information systems between central and/or field offices. However, to ensure the rapid convergence and scale-up of operational with market/brand creation processes within the enterprise, the EMP System 100 should be integrated with existing and/or future ERP systems 200 as soon as practicable. As such, system connectivity issues between the EMP and the ERP should be resolved early in the EMP process to ensure that market and business—critical information is efficiently captured, stored and routed to appropriate EMP System 100 and ERP System 200 users for timely responses to competitive market opportunities and risk

The EMP PMO System 170 continues to report to the Strategy Module 140 through shared document views throughout the duration of the Phase 2 EMP Project Deployment where linkages to the Corporate Planning function 01 is maintained. The Strategy Module 140 (which may at Phase 2 reside within the Corporate Planning Function or leads the Strategic Brand Unit within the CEO's office) remains as the custodian of the EMP Strategic Blueprint (SB) throughout the EMP deployment where direct access to the PMO System 170 and the CSE Portal 160 enables the function to advise and shape information flows either through or from the Corporate Planning function 01.

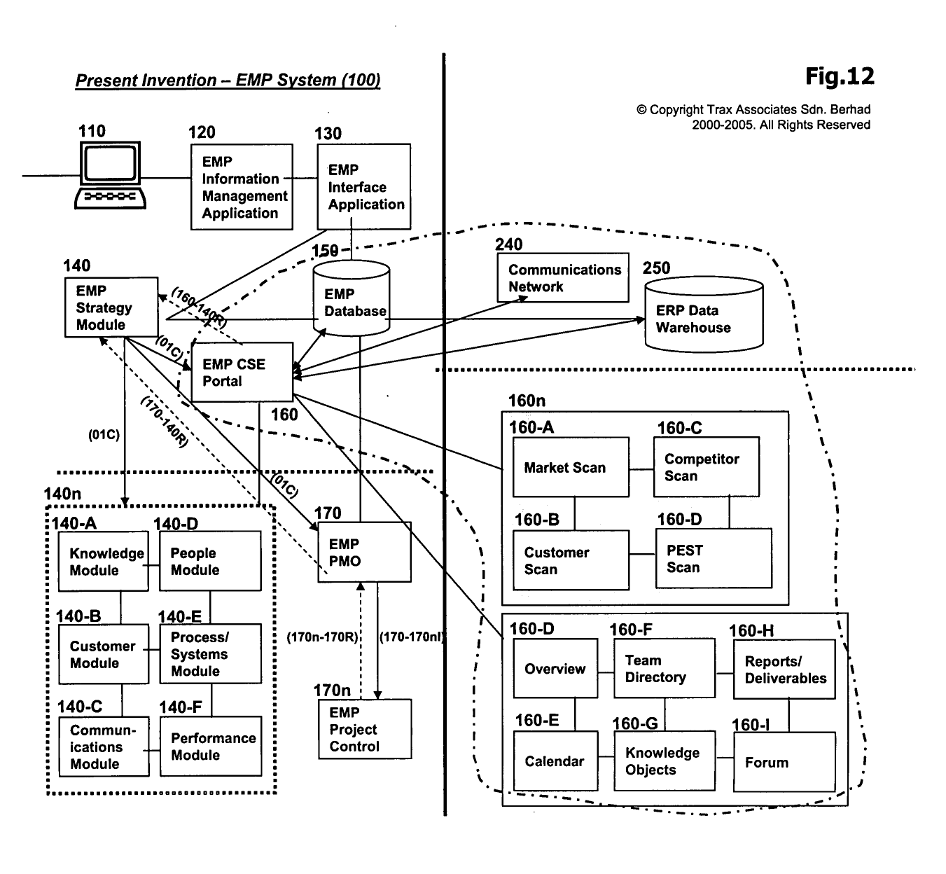

FIG. 12 illustrates within the present invention, the CSE Portal 160 and its subsidiary modules 160n which tracks and responds to market/customer and competitor activity through internal links with one or more objects in the EMP Database 150 and ERP Data Warehouse 250. In addition to these internal links, users may be able to capture external information through Communications Network 240 which when combined with customer data from Data Warehouse 250 may be analysed for storage and shared viewing/responses at the CSE Portal 160. The external market and internal customer tracking process ensures that business strategies deployed remains dynamic and responsive to market, customer and competitor trends and serves as an important audit mechanism in the management of fluid market and competitive movements.

The CSE Portal 160 also seeds the beginnings of a strategic knowledge management function for enterprises without strong knowledge and information management systems and transitions the enterprise towards a more focused and robust knowledge management (KM) capability in the short to medium term. As a key application to the delivery of EMP objectives, the CSE Portal plays a dual role on the EMP System. During the EMP Phase 1 strategic blueprinting phase, the CSE Portal 160 scans and recommends to the Strategy Module 140 differentiation opportunities in the context of the competitive environment from market information from internal and external sources. During the EMP Phase 2 Project Chartering and Deploymen phase, the CSE Portal 160 acts as a parallel market “tracker” to existing performance measures and key performance indicators (KPIs) within an enterprise where the qualitative analyses of data collected may validate and/or query current internally-generated, quantitative KPIs and balance scorecards.

The CSE Portal 160 comprises of four (4) subsidiary modules: (1) the external Environment Scan, (political, economic, social and technology scan) or PEST Scan, (2) the internal and external customer environment scan which includes both internal and external stakeholders (the Customer Scan), the target Market Scan and the Competitor Scan.

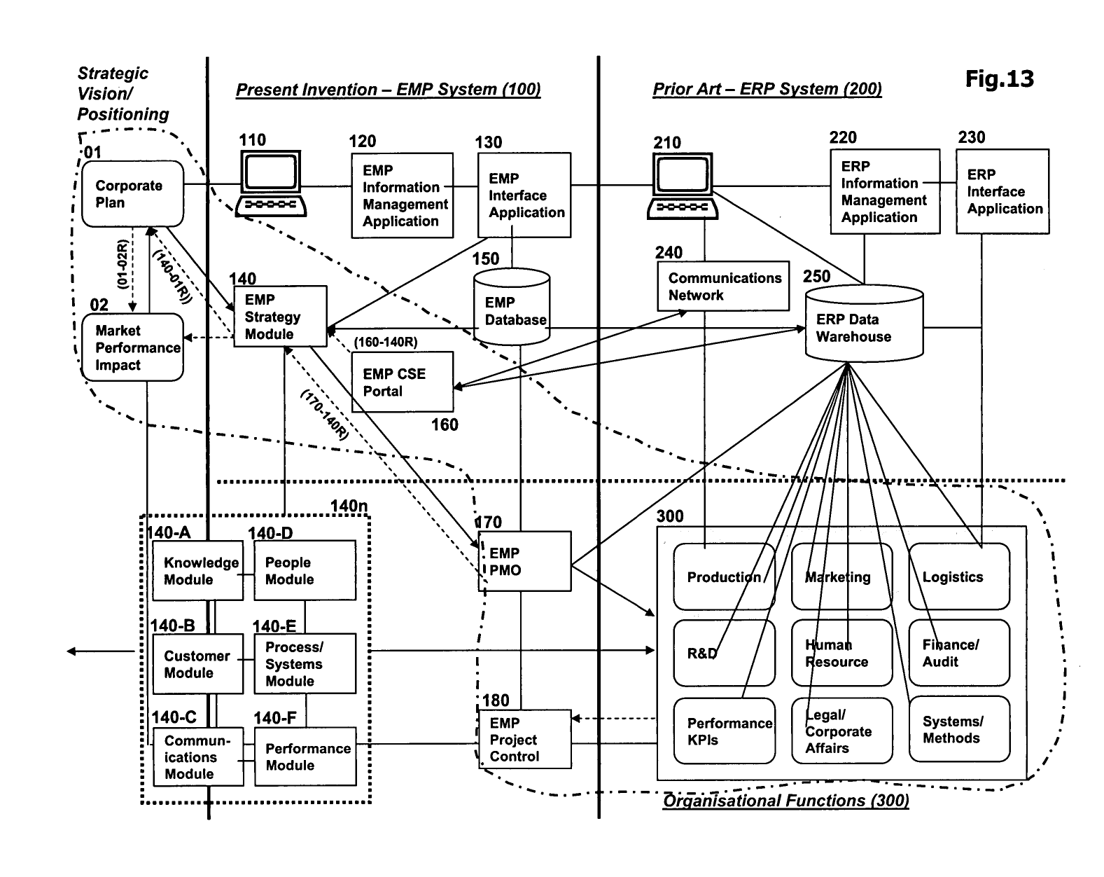

FIG. 13 is a block diagram detailing the strategic relationship between the present invention, the EMP System 100 with the ERP system 200 (the prior art) where market-facing processes may begin to converge with back-office processes through the PMO System 170 in Phase 3. (FIG. 2) Here, market/customer data inputs from the EMP System 100 within an organisation modulates strategic corporate responses through external information from the CSE portal 160, and integrated organisational responses from EMP PMO 170. It is also at this phase where emerging brand and/or emerging market companies accelerate the institutionalisation of market and brand-aligned processes and systems to become a more competitive market-driven organisation. (FIG. 1) As corporate and organisational structures become more complex around the world, the ability to remain agile is being delivered through multi-skilled project teams with both the competency and empowerment to rapidly respond. For emerging brand companies, the sustenance of the CSE, PMO and EMP Systems within the EMP System 100 would ensure that the transition from emerging to developed market and developed brand competencies are accelerated as they compete for market shares around the world.

Through a report writer, information from the PMO System 170 and the CSE Portal 160 may be translated for immediate and/or phased access to the Chief Executive Officer (CEO) and assigned management personnel through EMP Interface Application 130. The shared view on historical market performance metrics (as measured in market share) and future market performance potential (as measured in mind share) is accessible to assigned users through the deployment of the EMP System 100.

Finally, while the invention has been shown and described with references to specific embodiments, it is understood by those skilled in the art that various changes or modifications in form and detail may be made without departing from the scope and spirit of this invention.

What is claimed:

1. A method of establishing a new category in enterprise marketing planning (EMP) comprising of:
a self-contained, integrated, stand-alone system with three interconnecting subsidiary systems: Enterprise Market Planning (EMP) Modules, Competitor Signalling Environment (CSE) Portal and EMP Project Management (PMO) System through which integration of operational with market planning data and processes at strategic and/or corporate planning levels may provide enhanced market competitiveness to emerging brand and emerging market companies without sufficiently deep process/systems integration knowledge, experience and capabilities;
a business mission-critical central data integration and messaging system with built-in content, formats, rules, and processes to enable the optimisation of business strategies within existing Enterprise Resource Planning systems (ERP) through strategic intervention of the Enterprise Market Planning system (EMP), wherein the EMP System is configured to reduce the lack of convergence between operational and market planning processes for improved investment prioritisation in competitive market and brand performance;
an integrated, modular, and content-rich enterprise market planning system designed to accelerate organisational learning, collaboration and competencies in market and brand competitiveness processes from market and customer knowledge to communications and technology alignment, market performance measures, rules and formats via a single, unified data access and retrieval point; and
an integrated business information management system that may shape essential market and brand convergence behaviours enterprise-wide among assigned users within emerging brand and/or emerging market enterprises seeking to align business activities, investments, systems and competencies in the building of stronger and more globally- competitive corporate, product and service brands.

2. A method of establishing a system in accordance to claim 1, said EMP systems are configured to perform a specific and inter-related activity through the EMP Module, CSE Portal and PMO systems comprising of market-focused business processes in auditing, budgeting, documentation, strategic product/service and brand portfolio design and blueprinting, customer and market knowledge management, communications integration, competitor activity scanning, people alignment, and measurement of process and systems impacting strategic market/brand performance.

3. A method of establishing a system according to claim 1, which through the EMP subsidiary systems and modules, when integrated, fulfils current gaps in enterprise knowledge, competencies and responses in strategic market/brand creation through simple, practical and easy-to-use collaborative and integrated workflows, wherein enterprise integration of back-office with market-facing business processes and systems may improve the competitiveness of companies seeking to strengthen the strategic alignment of business investments with market opportunities and risks.

4. A method of establishing a system according to claim 1, wherein said EMP systems performs a specific cluster of inter-related activities within its own separate database that do not link to the central or ERP data warehouse, but which may in future be migrated to legacy or new ERP systems via middleware integration type devices.

5. A method of establishing a system according to claim 4, where data integration through communications and/or middleware devices as part of its design, accommodates multi-adaptive platforms and applications standards in information sharing.

6. A method of establishing a system according to claim 1, that when the multiple EMP systems and modules are integrated, enables the new user without comparative and/or competitive market and/or brand knowledge to accelerate learning and competencies at individual and team levels in enterprise market planning through pre- programmed “drop down” cues, graphic user interface (GUI) and solution “help” features for collaborative inputs and shared learning throughout the organisation.

7. A method of establishing a system according to claim 1, that when multiple EMP systems and modules are integrated with existing and/or future ERP systems, enables an enterprise to employ a strategic market and brand information management system through easy to access content for users who may collaborate to build new and proprietary enterprise skills in strategic response to competitive market environments.

8. A method of establishing a system according to claim 1, that when the multiple EMP systems and modules are integrated, enterprises at nascent stages of economic growth with relatively finite resources may be able to improve investment prioritisations (e.g. strategic investment decisions on systems, process, competency and third party enablement) through new EMP insights in enhanced market, customer and competitor knowledge management.

9. A method of establishing a system according to claim 8, that when multiple EMP systems and modules are integrated, it improves the capture of information on pre-defined investments in the specific company, business unit, product and/or service portfolio through established charge codes within document formats—enabling the analysis of such information for future investment, valuation or divestment decisions.

10. A method of establishing a system according to claim 1 where the early mediation of the EMP system “filter” to ERP installations will improve the potential for better deployment of people, process and systems enablement and improve the convergence of operational with market processes and systems within existing ERP systems wherein prior installation of an EMP System may also determine the sequencing and priorities of the ERP systems infrastructure, and the sophistication of user knowledge required to maximise ERP and/or other technology requirements.

11. A method of establishing a system according to claim 1, that when multiple EMP systems and modules are integrated and deployed with the support of development tools and interface applications of the major technology providers (e.g. Microsoft and/or IBM Lotus Notes), it enables users to customise generic formats within the EMP system to accommodate particular business objectives and process workflows.

12. A method of establishing a system according to claim 11, where settings designed within the EMP information management system on “packaged” or bundled applications of major technology providers offer users the ability to customise workflows between the EMP and the ERP systems without the need for additional or complex programming support.

13. A method of establishing a system according to claim 11, where the deployment of the invention through “packaged” or bundled applications of major technology providers may reduce the implementation costs and risks where users are already familiar with the generic system interface and therefore may be able to rapidly deploy the EMP solution without extended application or proof of concept.

14. A method of establishing a system according to claim 6, that when the multiple EMP systems and modules are integrated, timely and enhanced access to competitor and market information through the CSE Portal may shape multi-user creativity, focus and speed in response to new knowledge otherwise not always accessible to enterprises without effective or integrated market and customer management capabilities.

15. A method of establishing a system according to claim 1, where each of the said EMP systems and modules is interconnected through easy-to-recognise graphics, colour codes, and communications devices where the information interchange within the system, workspace and learning tools are inherently part of the EMP System proprietary application, functionality, structure and design.

16. A method of establishing a system according to claim 1, that provides a means for users and applications to transmit and receive information between EMP system components in real time and batch formats.

17. A method of establishing a system in accordance to claim 6, where the evolving knowledge base of best practices in enterprise market planning as the core system functionality, offers customised codes/formats to accelerate market and brand process requirements, systems interfaces and data entry via shared views to users such that predetermined codes/formats shapes data inputs in market, customer and competitor activity reducing the need for ad hoc market and brand audits.

18. A method of establishing an enterprise market planning system according to claim 8 where the EMP “filter” to the enterprise resource planning (ERP) function intercedes with market-critical information illuminating opportunities for the prioritisation and sequencing of strategic investments in systems, competencies, and infrastructural requirements such that said sequencing and prioritisation of investments may improve the enterprise's ability to manage and control corporate growth in tandem with evolving market opportunities and risks.

19. A method of establishing an enterprise market planning system that in accordance with claim 6, with its customised codes, predetermined formats, rules, interfaces and data inputs enable enterprises without the advantage of sophisticated development environments to accelerate replication and customisation of the integrated EMP systems and modules enterprise-wide, wherein each or a combination of modules within the EMP system could further evolve into new and strategic competencies in enhanced market management within such organisations.

20. A method of establishing a system according to claim 1 where the structured access, integration and replication of best practices in market and brand creation embodied in the EMP design may enhance the strategic information management and sustainability of competitive capabilities of emerging brand and/or emerging market enterprises.
